(19) United States
(12) Patent Application Publication
(10) Pub. No.: US 2025/0069049 A1
(43) Pub. Date: Feb. 27, 2025

(54) SYSTEMS AND METHODS FOR ESTABLISHING AND MAINTAINING A GROUP ACCOUNT

(71) Applicant: Wells Fargo Bank, N.A., San Francisco, CA (US)

(72) Inventors: Ashish B. Kurani, Hillsborough, CA (US); Alan W. Hecht, Chanhassen, MN (US); Muhammad Farukh Munir, Pittsburg, CA (US); Darius A. Miranda, San Francisco, CA (US); Benjamin Taylor, Willston, VT (US); Traci Nguyen, San Francisco, CA (US); Kourtney Eidam, Marietta, GA (US); Wairnola Marria Rhodriquez, San Francisco, CA (US)

(73) Assignee: Wells Fargo Bank, N.A., San Francisco, CA (US)

(21) Appl. No.: 18/238,362

(22) Filed: Aug. 25, 2023

(51) Int. Cl. G06Q 20/10

(52) U.S. Cl. CPC G06Q 20/10

(57) ABSTRACT

Systems and methods for providing notifications regarding a shared account may include a computing system which receives a request to form a shared account. The computing system may generate the shared account and a corresponding first model, transmit one or more messages, generate links between accounts and the shared account and second model(s) corresponding to second member(s). The computing system may receive a first input indicating a selection to initiate an inbound transfer, transmit a notification according to the first and second model(s), and receive a second input indicating a selection to initiate a matching inbound transfer.

### TECHNICAL FIELD

The present disclosure relates to account management including systems and methods for establishing and maintaining a group account.

### BACKGROUND

Many methods for sharing expenses, transferring funds, and loaning money exist. Conventionally, a person wishing to procure funds with other people of various financial institutions does so through third party fund exchanges, which does not allow the person to effectively manage the funds. Accordingly, computerized systems and methods of establishing and managing a group account for various users may be desired.

### SUMMARY

The present disclosure is related to systems, methods, and computer readable media for providing notifications regarding a shared or group account.

At least one aspect of the present disclosure is related to a computing system including a network interface; a database structured to store a plurality of shared accounts containing group member information; and a processing circuit comprising one or more processors and a memory, the processing circuit configured to: receive, via the network interface, a request from a first user device associated with a first member, the request to form a shared account with one or more second members, the request including information for identifying a first account of the first member; generate, in the database, the shared and a first model for the shared account, the shared account including a first link between the shared account and the first account, and the first model generated according to the shared account; transmit, via the network interface, one or more messages to one or more second user devices associated with the one or more second members; generate, in the database, one or more second links between one or more second accounts of the one or more second members and the shared account, the one or more second links generated according to a response to the one or more messages received from the one or more second user devices; generate one or more second models for the first member and the one or more second members, the one or more second models generated according to information relating to respective members of the first member and the one or more second members; receive, via the network interface, a first input via the first user device indicating a selection to initiate an inbound transfer from the first account to the shared account, to increase a value associated with the shared account by an amount; and transmit, via the network interface, according to the first model and at least one second model of the one or more second models, a notification to the one or more second user devices; and receive, via the network interface, a second input via at least one second user device indicating a selection to initiate a matching inbound transfer to the shared account, to increase the value associated with the shared account by the amount.

In some embodiments, the computing system may receive, from at least one of the first device or the one or more second devices, data indicative of a notification policy for the shared account. In some embodiments, the data indicative of the notification policy for the shared account is received from the first device with the request to form the shared account. In some embodiments, transmitting the notification to the one or more second user devices includes transmitting, according to the first model and the at least one second model, a first notification to the at least one second user device, and transmitting, according to the first model and at least one other second model, a second notification to at least one other second user device. In some embodiments, the computing system may receive, from the at least one other second user device, a declination of the matching inbound transfer. The computing system may update the at least one other second model according to the declination.

In some embodiments, the computing system may determine, for a second user of the one or more second members, a transaction history associated with a second account of the second user. The computing system may determine, according to the transaction history, a recommendation for a second inbound transfer. The computing system may transmit, according to a second model of the one or more second models corresponding to the second member, data corresponding to the recommendation to a device of the second user. In some embodiments, the computing system may receive data indicative of one or more target values of the account and a corresponding target date. The computing system may store an association of the one or more target values and the corresponding target date with data corresponding to the shared account. In some embodiments, the computing system may transmit, according to the first model, one or more notifications based on a difference between a current value associated with the shared account and the one or more target values and a difference between a current date and the corresponding date. In some embodiments, the data indicative of the one or more target values and the corresponding date is received with the request to form the shared account. In some embodiments, the computing system may initiate the inbound transfer and the matching inbound transfer according to the first input and the second input.

At least one aspect of the present disclosure relates to a method. The method includes: receiving, by a computing system, a request from a first user device associated with a first member, the request to form a shared account with one or more second members, the request including information for identifying a first account of the first member; generating, by the computing system, the shared account and a first model for the shared account, the shared account including a first link between the shared account and the first account, and the first model generated according to the shared account; transmitting, by the computing system, one or more messages to one or more second user devices associated with the one or more second members; generating, by the computing system, one or more second links between one or more second accounts of the one or more second members and the shared account, the one or more second links generated according to a response to the one or more messages received from the one or more second user devices; generating, by the computing system, one or more second models for the first member and the one or more second members, the one or more second models generated according to information relating to respective members of the first member and the one or more second members; receiving, by the computing system, a first input via the first user device indicating a selection to initiate an inbound transfer from the first account to the shared account, to increase a value associated with the shared account by an amount; and transmitting, by the computing system, according to the first model and at least one second model of the one or more second models, a notification to the one or more second user devices; and receiving, by the computing system, a second input via at least one second user device indicating a selection to initiate a matching inbound transfer to the shared account, to increase the value associated with the shared account by the amount.

In some embodiments, the method includes receiving, by the computing system from at least one of the first user device or the one or more second user devices, data indicative of a notification policy for the shared account. In some embodiments, the data indicative of the notification policy for the shared account is received from the first user device with the request to form the shared account. In some embodiments, transmitting the notification to the at least one second user devices includes: transmitting, by the computing system, according to the first model and the at least one second model, a first notification to the at least one second user device; and transmitting, by the computing system, according to the first model and at least one other second model, a second notification to at least one other second user device. In some embodiments, the method includes: receiving, by the computing system, from the at least one other second user device, a declination of the matching inbound transfer; and updating, by the computing system, the at least one other second model according to the declination.

In some embodiments, the method includes: determining, by the computing system, for a second user of the one or more second members, a transaction history associated with a second account of the second user; determining, by the computing system, according to the transaction history, a recommendation for a second inbound transfer; and transmitting, by the computing system, according to a second model of the one or more second models corresponding to the second member, data corresponding to the recommendation to a device of the second user. In some embodiments, the method includes: receiving, by the computing system, data indicative of one or more target values of the shared account and a corresponding target date; and storing, by the computing system, an association of the one or more target values and the corresponding target date with data corresponding to the shared account. In some embodiments, the method includes transmitting, by the computing system according to the first model, one or more notifications based on a difference between a current value associated with the shared account and the one or more target values and a difference between a current date and the corresponding date. In some embodiments, the data indicative of the one or more target values and the corresponding date is received with the request to form the shared account. In some embodiments, the method includes initiating, by the computing system, the inbound transfer and the matching inbound transfer according to the first input and the second input.

At least one other aspect of the present disclosure is relates to a non-transitory computer readable medium storing instructions that, when executed by one or more processors of a processing system, cause the processing system to: receive, via a network interface, a request from a first user device associated with a first member, the request to form a shared account with one or more second members, the request including information for identifying a first account of the first member; generate, in a database, the shared account and a first model for the shared account, the shared account including a first link between the shared account and the first account, and the first model generated according to the shared account; transmit, via the network interface, one or more messages to one or more second user devices associated with the one or more second members; generate, in the database, one or more second links between one or more second accounts of the one or more second members and the shared account, the one or more second links generated according to a response to the one or more messages received from the one or more second user devices; generate one or more second models for the first member and the one or more second members, the one or more second models generated according to information relating to respective members of the first member and the one or more second members; receive, via the network interface, a first input via the first user device indicating a selection to initiate an inbound transfer from the first account to the shared account, to increase a value associated with the shared account by an amount; and transmit, via the network interface, according to the first model and at least one second model of the one or more second models, a notification to the one or more second user devices; and receive, via the network interface, a second input via at least one second user device indicating a selection to initiate a matching inbound transfer to the shared account, to increase the value associated with the shared account by the amount.

This summary is illustrative only and is not intended to be in anyway limiting. Other aspects, inventive features, and advantages of the devices or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

FIG. 1 is a block diagram of a computing system for establishing and maintaining a group account in furtherance of one or more group goals, according to an example embodiment.

FIG. 2 is a flow diagram of a method of generating a shared account, according to an example embodiment.

FIG. 3 is a block diagram displaying attributes of a shared account, according to an example embodiment.

FIG. 4 is a flow diagram of method of providing notifications regarding opportunities to members of a shared account, according to an example embodiment.

FIG. 5 is a flow diagram of a method of providing notifications regarding matching inbound transfers, according to an example embodiment.

FIG. 6 depicts example graphical user interfaces displayed on a customer or user device regarding a shared account, according to example embodiments.

### DETAILED DESCRIPTION

Referring generally to the Figures, systems, computer-readable media, and methods for providing notifications regarding a group or shared account are described according to various embodiments herein. According to the various embodiments described herein, a provider computing system may provide end-users an application (e.g., via their respective devices) which facilitates establishing and maintaining a shared account. In particular and as described herein, the shared or group account may be established or created in connection with a common interest, such as a group goal service. As described herein, selective notifications may be generated and provided by the provider computing system regarding individual user activity associated with the group account. The notifications may include a link to encourage other users associated with the group account to contribute to the group account (e.g., in a matching amount as a first user). The systems, computer-readable media, and methods provided herein may additionally include analyzing individual behavior and providing recommendations to help achieve a group goal, and comparing multiple users' behaviors with one another to determine which are most likely to help achieve a group goal.

As an example, a first user, via the mobile application provided by the provider computing system, may send invites to family, friends, groups he/she is a part of, etc. to join a group goal service provided by the provider institution. The provider computer system (or user device/mobile application) may provide a passcode or other credential to other users. The users may provide the passcode or credential as part of enrollment, such that any user can be enrolled with any number of groups. After enrollment, each user may selectively add one or more accounts to the application. For privacy, the account information may be hidden from view from the other group members. However, this information may be used by the system to make intelligent recommendations.

As part of establishing the shared account (or at any point during the life of the shared account), the provider computer system may receive a group objective, such as a goal. The group goal may be a savings goal, such as raising funds to a particular level for a particular purpose. Activities, or selected activities, may be shared by the provider computer system amongst the group. For example, if User A deposits $X into the shared account, a notification is then sent to the group members indicating that User A deposited $X. The notification may include a link to facilitate the other members to match the deposit or provide a deposit of their own selected amount. The system may also provide analytics notifications, such as determining a savings amount-per-day that is communicated to each individual in order to meet the goal by a certain deadline. The savings amount-per-day may be specific to each individual linked to the group account (e.g., user A has a goal of $A/day while user B has a goal of $B/day). The provider computing system may perform various analytics, as described herein, to arrive at these individual determinations.

According to the systems, computer-readable media, and methods described herein, by linking to the individual's connected accounts, the provider computer system may analyze spending/savings patterns of the individual and provide targeted notifications with recommendations to help the individual save individually while also save for the group. For example, the system may identify a twice-a-week $5.00 coffee expenditure and provide a notification (e.g., a “nudge”) to forego one coffee and commit the $5.00 to the group goal because it will help achieve the group's goal faster. Thus, the system is continuously analyzing individual behaviors and attempting to modify the behavior of the individual to meet the goal(s) of the group. While described in the context of individual account holders, the systems and methods described herein may be applied to small businesses as well. For example, a small business owner that has aging parents, children, etc. may have a goal. The system determines tradeoffs that the person needs to make in their personal life to achieve the goal in their professional life.

Technically and beneficially, the systems and methods described herein provide various technical solutions to the various problems and shortcomings of conventional resource transfer systems as alluded to above. For example, the systems and methods described herein operate in a non-conventional way by coupling users for a shared objective to manage a pool of resources fairly and efficiently. Furthermore, the systems and methods described herein provide a unique way to automatically analyze transaction history of a user by allowing the user to selectively determine which types of funds are analyzed. This is unconventional and facilitates reducing processing power (e.g., the computing systems described herein only analyze relevant historical data). Accordingly, the systems and methods described herein provide a non-conventional operation of allowing members to pool resources together in a safe, efficient manner. Various other technical benefits and advantages are described in greater detail below.

Before turning to the figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

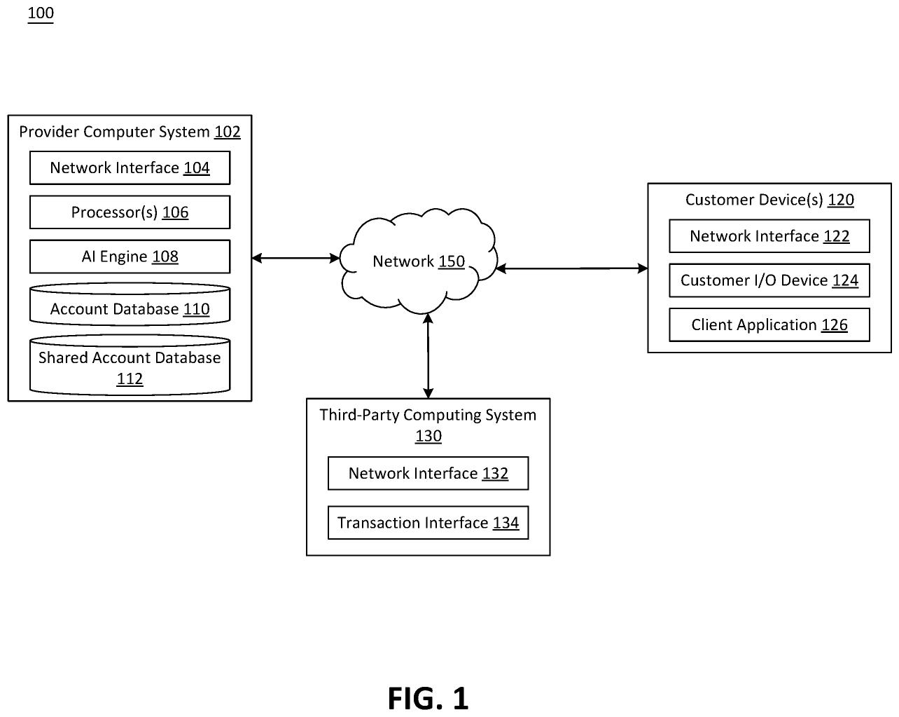

FIG. 1 is a diagram of a computing environment 100 for establishing and maintaining a group or shared account in furtherance of one or more group goals, according to an example embodiment. As shown, the computing environment 100 includes one or more provider computing systems 102 associated with a provider (e.g., a provider of goods and/or services, such as a financial institution), one or more customer devices 120 associated to one or more users, one or more third-party computing systems 130 (“third-party” relative to the provider), and a network 150 which may include one or more of the Internet, cellular network, Wi-Fi, Wi-Max, a proprietary banking network, or any other type of wired or wireless network or a combination of wired and wireless networks. As described herein, the computing environment 100 may be used to provider a user interface to the first customer device or the second customer device to allow for easy account management and resource management between/across various accounts of the user.

For clarity, the following description will refer to a provider computing system 102, one or more customer devices 120, and a third-party computing system 130. However, it will be understood that the following description of any of these devices and computing systems will be similarly applicable to any additional corresponding devices and computing systems (e.g., additional provider computing systems 102) and that, in some embodiments, the computing environment 100 may include a plurality of any of the described devices and systems.

The provider computing system 102 may be owned by, associated with, or otherwise operated by a provider institution. In this example, the provider institution is a provider of goods and/or services and, in particular, is a financial institution, such as a bank, a credit union, or other financial institution that maintains one or more accounts held by various customers (e.g., the customer associated with the customer device 120), such as demand deposit accounts, credit card accounts, receivables accounts and so on. As described in greater detail below, the provider computing system 102 may be configured to maintain one or more shared accounts held or maintained for a plurality of customers of the provider financial institution or other users (e.g., customers of third party financial institutions). Such a shared account may be accessible by each of the plurality of customers or users, such that the customers or users may be capable of transferring funds between (e.g., to and/or from) the shared account and an individual (e.g., non-shared, such as business or personal) account. The shared account may be shared across multiple customers or users.

In some embodiments, the provider computing system 102 may include one or more servers, each with one or more processing circuits having one or more processors 106 configured to execute instructions stored in one or more memory devices to send and receive data stored in the one or more memory devices and perform other operations to implement the methods described herein associated with logic or processes shown in the figures. In some embodiments, the provider computing system 102 may be or may include various other devices communicably coupled thereto, such as, for example, desktop or laptop computers (e.g., tablet computers), smartphones, wearable devices (e.g., smartwatches), virtual reality devices (e.g., headsets), and/or other suitable devices.

In some embodiments, the provider computing system 102 includes an AI engine 108, an accounts database 110, a shared accounts database 112 and a network interface 104. In some embodiments, the network interface 104 includes, for example, program logic that connects the provider computing system 102 to the network 150. The network interface 104 facilitates secure communications between the provider computing system 102, customer device(s) 120, and/or a third-party computing system 130. The network interface 104 also facilitates communication with other entities such as other banks, settlement systems, and so on. The network interface 104 further includes user interface logic configured to generate and present web pages and graphical user interfaces to users accessing the provider computing system 102 over the network 150.

The AI engine 108 may be a set of computer code comprising various models and/or other logic that may be embodied in a separate server(s) relative to the provider computing system. The AI engine 108 may be configured as or include a large language model (LLM), machine learning model, generative adversarial network (GAN), or any other type of artificial intelligence designed or configured to maintain and use various models for predicting/categorizing/determining individual and/or group behaviors. In some embodiments, the AI engine 108 may be configured to generate and maintain one or more individual models for individual users, and one or more group models for a group of individual users (e.g., each associated with a respective shared account). In other words, at least one group model for each group or shared account may be generated and maintained by the AI engine 108. As described in greater detail below, the AI engine 108 may be configured to update, revise, train, or otherwise tune individual/group models based on feedback, to provide recommendations for behaviors that result in a group goal.

The account database 110 is structured or configured to contain, store, include, or otherwise maintain information on financial accounts associated with the provider. Additionally, the account database 110 may contain transaction information, information pertaining to the type and corresponding capabilities of a given account. Similarly, the shared account database 112 is structured or configured to maintain a plurality of shared accounts and associated information (e.g., shared account members, linked financial accounts, customer device information, etc.). As described in greater detail below, the provider computing system 102 may be configured to generate, create, or otherwise establish new shared accounts (e.g., responsive to received requests from various user devices). As part of establishing shared accounts, the provider computing system 102 may be configured to generate various notifications to devices associated with shared members (e.g., members identified in the request with which the shared account is to be shared). The provider computing system 102 may be configured to establish various links between the financial accounts (e.g., between the shared account of the shared accounts database 112 and accounts of the accounts database 110) based on responses from the devices to the various notifications.

The customer device(s) 120 may be owned, operated, controlled, managed, and/or otherwise associated with a respective customer (e.g., a customer of the financial institution). In some embodiments, the customer device 120 may include, for example, a desktop or laptop computer (e.g., a tablet computer), a smartphone, a wearable device (e.g., a smartwatch), a personal digital assistance, a virtual reality device (e.g., virtual reality headset), and/or any other suitable computing device. In the example described herein, the customer device 120 is structured as a mobile computing device, namely a smartphone.

The network interface 122 includes, for example, program logic and various devices (e.g., transceivers, etc.) that connect the customer device 120 to the network 150. The network interface 122 facilitates secure communications between customer device(s), third-party computing systems, and/or the provider computing system 102. The network interface 122 also facilitates communication with other entities, such as other banks, settlement systems, and so on.

In some embodiments, the customer device 120 includes one or more I/O devices 124, and one or more customer client applications 126. While the term “I/O” is used, it should be understood that the I/O devices 124 may be input-only devices, output-only devices, and/or a combination of input and output devices. In some instances, the I/O devices 124 include various devices that provide perceptible outputs (such as display devices with display screen and/or light sources for visually perceptible elements, an audio speaker for audible elements, and haptics or vibration devices for perceptible signaling via touch, etc.), that capture ambient lights and sounds (such as digital cameras, microphones, etc.), and/or that allow the customer to provide inputs (such as a touchscreen display, stylus, keyboard, force sensor for sensing pressure on a display screen, acceleration sensor for tracking motion, etc.). In some instances, the I/O devices 124 further include one or more user interfaces (devices or components that interface with the customer), which may include one or more biometric sensors (such as a fingerprint reader, a heart monitor that detects cardiovascular signals, face scanner, an iris scanner, etc.).

The customer device 120 stores in computer memory and executes (“runs”) using one or more processors, various customer client applications, such as an Internet browser presenting websites, text messaging applications (e.g., for sending MMS or SMS to the provider computing system 102, another customer device 120, and/or the third-party computing system 130), and/or applications provided or authorized by entities implementing or administering any of the computing systems in computing environment 100.

In the example shown, the client application 126 is a customer provider institution client application (e.g., a financial institution banking application) provided by and at least partly supported by the provider computing system 102. For example, in some instances, the client application 126 coupled to the provider computing system 102 may enable the customer to perform various customer activities (e.g., transferring money to another financial account, etc.) associated with one or more customer accounts of the customer held at the provider institution associated with the provider computing system 102 (e.g., account opening and closing operations, fund transfers, etc.). In some arrangements, the client applications 126 are hard coded onto the memory of the customer device 120. In another embodiment, these applications are web-based interface applications, where the user has to log onto or access the web-based interface before usage, and these applications are supported by a separate computing system comprising one or more servers, processors, network interface circuits, or the like (e.g., the provider computing system 102), that transmit the applications for use to the mobile device. In some arrangements, the client application 126 may be an application downloaded by a user via an app store or mobile wallet provider.

The third-party computing system 130 is controlled by, managed by, owned by, and/or otherwise associated with an entity (e.g., an account provider external to the provider associated with the provider computing system 102) that is configured to transmit information to the provider computing system 102. Although not specifically shown, it will be appreciated that the third-party computing system 130 may include a network interface 132, a transactions interface 134, various databases (e.g., similar to the user profile database 104), and/or processing circuits comprising processor(s) and memory device(s) in the same or similar manner to the other components of computing environment 100. As described herein, the entity may be one or more providers of an account capable of initiating a transaction. In the example shown, the third-party computing system 130 is associated with a credit provider, such as a credit company, and as such may be referred to herein as a credit third-party computing system 130. It should be appreciated that while only one entity is depicted, the system may include a plurality of entities.

With an example structure of the computing environment 100 being described above, example processes performable by the computing environment 100 (or components/systems thereof) will be described below. It should be appreciated that the following processes are provided as examples and are in no way meant to be limiting. Additionally various method steps discussed herein may be performed in a different order or, in some instances, completely omitted. These variations have been contemplated and are within the scope of the present disclosure.

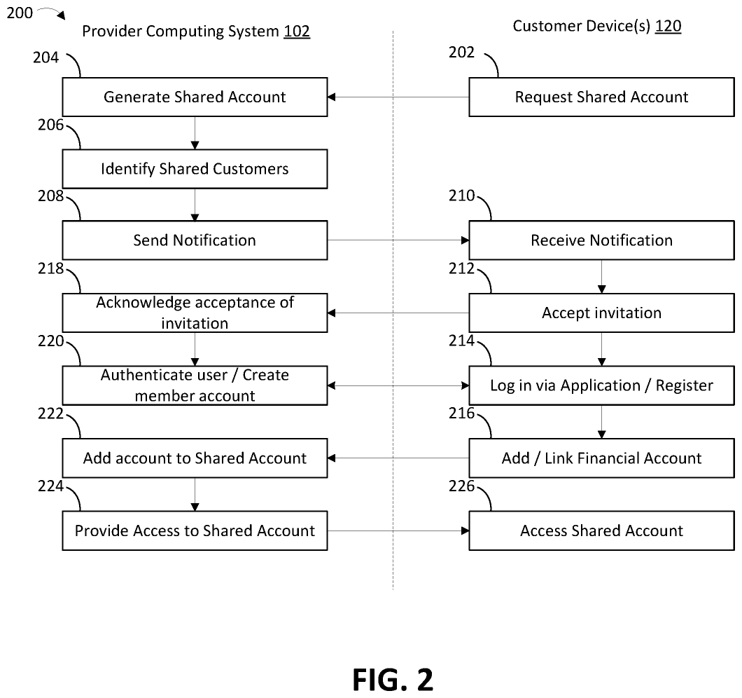

Referring now to FIG. 2, depicted is a flowchart showing an example method 200 of generating a shared account, according to an example embodiment of the present disclosure. The method 200 may be performed by the components, elements, and/or hardware described above with reference to FIG. 1 (for example, the provider computing system 102 and various customer devices 120). In various embodiments, one customer device 120 may perform one or more of the steps, the provider computing system 102 may perform one or more other steps, and one or more additional customer devices 120 may perform one or more of the steps. In this regard, the various steps of the method 200 may be performed by various combinations of the devices/elements/hardware described above with reference to FIG. 1.

At step 202, a customer device 120 may initiate, generate, create, or otherwise provide a request to generate a shared account. The customer device 120 may generate the request via the client application 126. For example, the customer device 120 may receive a credential for the application via the customer I/O device 124. The customer device 120 may verify a user based on the credential. The customer device 120 may render information of an account associated with the credentials via the client application 126. The customer device 120 may be configured to render a selectable option for a user to create a request to generate a shared account. For example, the client application 126 may include a drop-down menu or similar selectable user interface element for a user to select to create a group account. Responsive to receiving the selection, the customer device 120 may be configured to receive an additional security metric of a user (e.g., biometric data, fingerprint data, etc.). For example, the customer device 120 may include an extra layer of security for generating a shared account request because such account may be stored separately from individual accounts (e.g., in an envelope within the account database 110 and/or within the shared account database 112).

Responsive to receiving the biometric data, the customer device 120 may generate the request based on or according to one or more inputs received via the customer I/O device 124 to the client application 126. The customer device 120 may generate the request to include information/data/inputs provided by a user of the customer device 120 to the client application 126. The one or more inputs may include, for example, information identifying a first account of the user (e.g., an account in the account database 110, such as an account number), information identifying one or more second users in which to share the account (e.g., usernames, email addresses, phone numbers, or other identifiers associated with the second users), etc. For example, in some implementations, the one or more inputs may include linking a social media account (e.g., by receiving log-in credentials associated with the social media account via an application programming interface (API) link) to identify users. In some implementations, the customer device 120 may receive an input indicating to query a database on the customer device 120 storing various contact information. Responsive to the receiving the input, the customer device 120 may be configured to establish an API link with the database (e.g., a contacts application stored on the customer device 120), and query the database for various contact information of one or more user names. The customer device 120 may be configured to transmit, communicate, send, or otherwise provide (e.g., via the network interface 122 over the network 150 to the provider computing system 102) to the request.

At step 204, the provider computing system 102 may receive (e.g., via the network interface 104) the request from the customer device 120. The provider computing system 102 may receive the request responsive to the customer device 120 generating and transmitting the request. At step 206, the provider computing system 102 may create, establish, or otherwise generate the shared account. In some embodiments, the provider computing system 102 may generate the shared account in the shared account database 112. The provider computing system 102 may generate the shared account by creating or establishing a new account number (e.g., associated with the shared account), and creating a link between one or more accounts of the account database 110 and the shared account. For example, the provider computing system 102 may generate a link between the shared account and the first account (e.g., for the user of the first customer device 120) based on or according to the information identifying the first account from the request.

In some embodiments, the provider computing system 102 may generate a distinct type of account number, or other identifier associated with the shared account, to indicate the account is a shared account and distinguish the account from other individual accounts (e.g., using alphanumeric codes such as “SH123AAABBBLLLL”). Generating a unique account number would enable quick processing of transactions into and out of the shared account by the provider computing system 102 to reduce processing power needed to manage the account. Further, the unique account number would insulate the shared account from other accounts to add more security (e.g., walls off shared accounts behind a firewall). In some embodiments, the provider computing system 102 may have separate credentials and/or security protocols needed for this account, as described herein, which makes it non-analogous to traditional demand deposit accounts. Additionally, the provider computing system 102 may generate a new envelope within the account database 110, or the shared account database 112, for the shared account, which transforms the account database 110 or the shared account database 112 in a non-routine manner. In some embodiments, the provider computing system 102 may be configured to generate the unique account number using hash computing using one or more individual account numbers associated with the members of the shared account. In such embodiments, the provider computing system 102 may be configured to reverse look-up each individual account number associated with the shared account based on a predefined hash account number generated for the shared account. At step 206, the provider computing system 102 may determine, detect, or otherwise identify one or more shared customers. The shared customers may be or include users which are identified in the request and which are to be provided access to the shared account. The provider computing system 102 may identify the shared customers based on or according to the information included in the request received at step 204. As stated above, as part of generating the request, a user of the first customer device 120 may include various identifiers associated with shared customers. The provider computing system 102 may identify the shared customers by performing a look-up function using the identifiers from the request in the account database 110. In some embodiments, the provider computing system 102 may generate one or more temporary links between identified accounts (e.g., identified responsive to or based on a returned result from the look-up function) in the account database 110 and the shared account.

At step 206, the provider computing system 102 may determine, detect, or otherwise identify one or more shared customers. The shared customers may be or include users which are identified in the request and which are to be provided access to the shared account. In some embodiments, the AI engine 108 may be configured to identify various recommended shared customers. For example, the AI engine 108 may be configured to generate a recommendation of shared customers by parsing a contact list of the first user and identifying familial relationships, friends, etc. The provider computing system 102 may transmit the recommended shared customers to the user, and receive a response identifying selected customers from the recommended shared customers. The provider computing system 102 may identify the shared customers based on or according to the information included in the request received at step 204. As stated above, as part of generating the request, a user of the first customer device 120 may include various identifiers associated with shared customers. The provider computing system 102 may identify the shared customers by performing a look-up function using the identifiers from the request in the account database 110. In some embodiments, the provider computing system 102 may generate one or more temporary links between identified accounts (e.g., identified responsive to or based on a returned result from the look-up function) in the account database 110 and the shared account.

At step 208, the provider computing system 102 may generate and communicate, transmit, send, or otherwise provide one or more notifications to customer devices associated with the identified shared customers. In some embodiments, the request received at step 204 may include a phone number or email address associated with the shared customer. The provider computing system 102 may provide the notification to the phone number (or email address or other token) included in the request. In some embodiments, the provider computing system 102 may provide the notification to a different address or device of a user responsive to performing the look-up function (if, for example, the user has a preferred mode of communication stored in association with the user's account in the account database 110 but not included in the request). The notifications may be or include an alert indicating or requesting enrollment of the user in the shared account (e.g., generated at step 206). The notifications may include a user interface for selecting or providing information relating to an account in which to link the shared account. The account of the user may be an account in the account database 110, or an account of a different financial provider (e.g., maintained by a third-party provider).

At step 210, various customer devices 120 (e.g., of shared customers or users) may receive the notification. The customer devices 120 may receive the notification(s) sent by the provider computing system 102 over the network 150 via the network interface 122. The customer devices 120 may receive the notification(s) as a pop-up or alert corresponding to the client application 126. The notification may include a prompt, user interface element, or other field for responding to the request to enroll. For example, the notification may include a user interface element (e.g., an enroll button) for selecting to enroll in the shared account, and another user interface element (e.g., a decline button) for declining the invitation to enroll in the shared account. At step 212, the customer device 120 may receive a selection to accept the invitation to enroll in the shared account (e.g., by the user selecting via the I/O device 124 the user interface element to enroll in the shared account).

At step 214, the customer device 120 may log into the client application 126 or otherwise access/register with the client application 126, to (e.g., at step 216) add or link the shared account with an account of the user. In some embodiments, the user of the customer device 120 may have an account associated with the provider computing system 102 (e.g., an account identified or maintained in the account database 110). In such embodiments, the user of the customer device 120 may log into the client application 126 and select the account identified or included in the client application 126. In some embodiments, the user of the customer device 120 may have an account with a different provider (or may otherwise link the shared account with an account outside of the provider associated with the provider computing system 102). In such embodiments, the user of the customer device 120 may create or establish an account with the client application 126. Once the account is established, the user may provide various inputs for establishing the link between the shared account and the customer's account. For example, the user may provide inputs for establishing the link by providing a routing and account number of the customer's account to a user interface of the client application 126. As another example, the user may provide inputs for establishing the link by selecting a provider associated with the customer's account on, e.g., a drop-down menu, log-into a portal associated with the selected provider, and select the corresponding account in which to establish the link.

At step 218, the provider computing system 102 may acknowledge acceptance of the invitation (e.g., responsive to step 212). For example, when the user selects the user interface element to accept enrollment of the invitation, the customer device 120 may transmit a ping or other packet indicating selection of enrollment. The provider computing system 102 may receive the ping/packet, and acknowledge the packet to the customer device 120. At step 220, when the user logs into or otherwise creates a new account with the client application 126, the provider computing system 102 may be configured to authenticate (e.g., responsive to logging into) or create (e.g., responsive to the user creating) the new account. At step 222, responsive to the user adding/linking the customer's account with the shared account, the information provided by the customer via the client application 126 may be transmitted, communicated, uploaded, or otherwise provided to the provider computing system 102. The provider computing system 102 may receive the information (e.g., identifying the customer's account) via the client application 126 from the customer. The provider computing system 102 may add the account (e.g., identified at step 216) to the shared account by establishing a second link to the account (e.g., thereby adding the user of the account as a shared member or shared user of the shared account). For example, the provider computing system 102 may establish the link by creating or storing account information of the customer's account in the shared account database 112 in association with the customer identifier for the customer and the shared account generated at step 204. At step 224 and step 226, after registering and generating the links, the provider computing system 102 may provide the user with access to the shared account (e.g., via the client application 126). The user (e.g., shared member) may access the shared account using the client application 126.

In various embodiments, a single user may be a shared member of multiple shared accounts (e.g., by repeating the process described above for multiple shared accounts). In other words, a shared account may have multiple shared users or members linked to the same account, and those shared members may be linked to multiple different shared accounts (e.g., which similar or other shared members). By being a shared member of a shared account, the provider computing system 102 may permit, facilitate, or otherwise provide the shared member access (e.g., via the corresponding client application 126 of the user) to interact (e.g., transact, initiate inbound/outbound transfers, provide group goals, etc.) with any given shared account to which the user is a shared member.

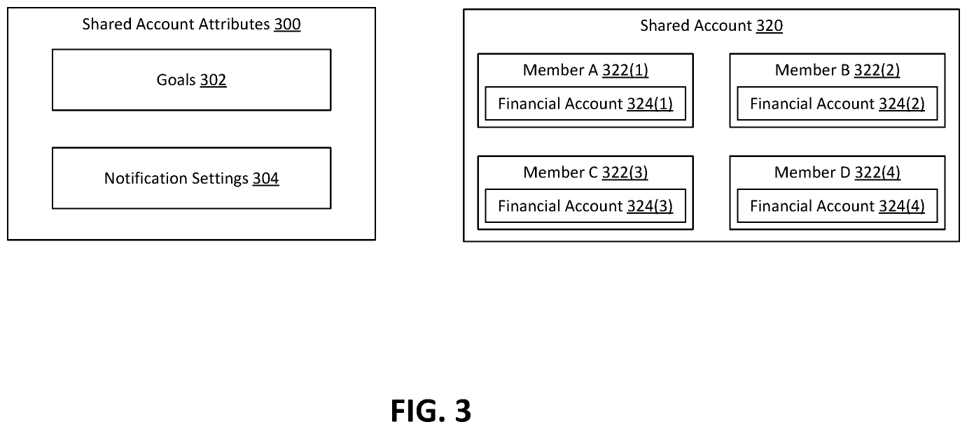

Referring now to FIG. 3, a block diagram of shared account attributes 300 for configuration/adjustment for a shared account along with a representation of the shared account 320 is shown, according to an example embodiment. The shared accounts attributes may be updated/configured as part of generating the request at step 202 described above. In some embodiments, the shared account attributes 300 may be or include account attributes of the shared account, such as whether the shared account is a lending shared account (e.g., an account in which members can selectively obtain a loan with funds from the lending account), a shared savings account (e.g., an account in which members can contribute for savings), etc.

In some embodiments, the shared account may include goals 302. For example, where the shared account is a shared savings account, the shared account may include one or more shared account attributes 300 comprising goals 302. The provider computing system 102 may be configured to receive data indicative of the goals 302 at enrollment (e.g., by any shared members), upon receipt of the request at step 202, etc. The data may include an amount (e.g., a target account value) and a purpose (e.g., the targeted purpose corresponding to the target account value). As one non-limiting example, a user may request a shared account for saving for a downpayment on a home, and may set a goal 302 as a target account value (e.g., equal to the downpayment value) and purpose (e.g., “downpayment”). The goals 302 may also include a target date (e.g., a date in which the goal is targeted to be achieved). The provider computing system 102 may be configured to store goal(s) 302 from any shared member(s) as a shared account attribute 300. The goals 302 may include individual goals for each member of the shared account (e.g., a user wishes to contribute $100 to the account in one month) and/or group goals for the collection of members of the shared account (e.g., the users wish to raise $1000 within the account within one month).

In some embodiments, the shared account may include notification settings 304. The notification settings 304 may be or include any configuration, rules, or settings which define, establish, or otherwise configure a notification policy relating to notifications which are to be sent to devices of shared members. In some embodiments, the notification settings 304 may include a frequency in which to provide notifications to shared members (e.g., weekly, bi-weekly, monthly, etc.). In some embodiments, the notification settings 304 may include a triggering event in which to provide notifications to shared members (e.g., responsive to a deposit to the shared account from one of the shared members). In some embodiments, the notification settings 304 may be user or member-specific notification settings 304 (e.g., one member may have a first set of notification settings 304 corresponding to a first notification policy and other member(s) may have another set of notification settings 304 corresponding to a second notification policy).

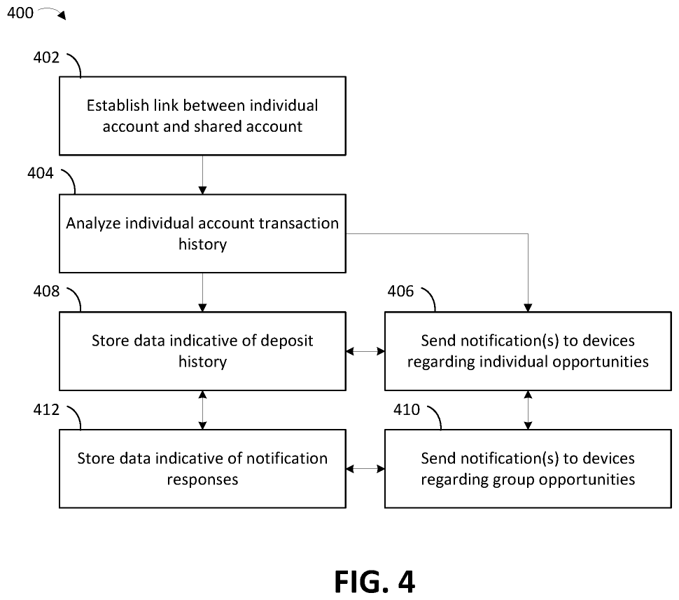

As described in greater detail below with reference to FIG. 4, the notification setting(s) 304 may be used to, for example, solicit matching deposits, prompt additional savings, or the like. For example, the provider computer system 102 may apply one or more notification policies in response to one or more triggering conditions (as described below), for providing notifications to devices of shared members. In some embodiments, the provider computer system 102 may apply a first notification policy (e.g., according to one or more group notification settings 304 of the shared account) to determine whether or not to provide a notification to at least some of the shared members in response to a trigger condition. In response to determining to provide a notification to at least some of the shared members, the provider computer system 102 may apply the trigger condition to one or more second notification policies (e.g., for the individual shared member(s)) to determine/select/identify which of the shared members to provide the notification. In various embodiments, the notification policies may be updated from time to time (e.g., based on feedback from individual models corresponding to end users/group model(s) corresponding to the shared account, based on updates to notification settings 304 provided by individual/account managers, etc.).

The shared account 320 retains a plurality of connected users 322 and their linked financial account 324. Each connected or registered user 322 may register with the shared account 320 as described above with reference to steps 210-214 of FIG. 2. Additionally, the connected users 322 may be configured to connect (e.g., add or link) the shared account with a financial account 324 of the user (e.g., an individual, or non-shared account). The financial account 324 may be an account in the account database 110 (e.g., an account with the provider of the provider computing system 102), or may be a third-party account (e.g., an account with a third-party financial provider or institution). Accordingly, such third-party financial account 324 may require interaction with the third-party computing system 130 in order to transact funds or receive transaction history. The users may link the financial account 324 with the shared account 320 as described above with reference to steps 216 and 222 of FIG. 2. While shown as four users or members linked to the shared account 320, it is noted that any number of users (e.g., greater than or equal to two) can be linked to the shared account 320.

Referring now to FIG. 4 together with FIG. 1-FIG. 3, depicted is a flowchart showing an example method 400 of providing notifications regarding opportunities to members of a shared account, according to an example embodiment. The method 400 may be performed by the devices, components, or elements described above with reference to FIG. 1, such as the provider computer system 102.

At step 402, the provider computer system 102 may generate, create, maintain, or otherwise establish a link between a first account of a shared member (e.g., an individual account) and the shared account. The provider computer system 102 may establish the link responsive to step 216 of FIG. 2. For example, the provider computer system 102 may establish a link between an account added at step 216 of FIG. 2 (e.g., by a member joining the shared account) and the shared account generated at step 204. The provider computer system 102 may establish the link based on information provided at step 216 (e.g., using an account and routing number of an external bank account, using a selected account from a list of accounts maintained by the provider computer system 102, etc.).

At step 404, the provider computer system 102 may parse, inspect, or otherwise analyze a transaction history of the individual account linked at step 402. In some embodiments, the AI engine 108 of the provider computer system 102 may receive the transaction history (e.g., as an input) to identify trends in transaction history (e.g., common or recurring transactions, transactions that are flagged as potential savings opportunities, etc.). For example, in some embodiments, the provider computing system 102 may be configured to parse transaction history of an individual account for a predetermined period of time (e.g., 1 year), extract the transaction history, and provide the history as an input to the AI engine 108. The AI engine 108 may be configured to identify recurring transactions and/or transactions in an amount above a specific threshold. By way of example, the AI engine 108 may be configured to determine a user makes a transaction at a coffee shop two times a week during the period of time. The AI engine 108 may be configured to identify the transactions as a potential saving opportunity (e.g., output the transaction history indicating the recurring transactions). In some embodiments, the AI engine 108 may receive the transaction history via the account database 110 (e.g., where the individual account is maintained by the provider computer system 102). In some embodiments, the AI engine 108 may receive the transaction history via the transaction interface 134 of the third-party computing system 130 (e.g., where the individual account is maintained by the third-party computing system 130).

In some embodiments, the provider computing system 102 may be configured to redact or ignore certain transactions of an individual account responsive to receiving inputs to a customer device 120. For example, the client application 126 may be configured to render a drop-box or other selectable user interface element for a user to selectively determine what transaction history is analyzed and what is not analyzed. By way of example, the customer device 120 may receive an input to ignore transactions at a pharmacy to increase the privacy of the user. As another example, the customer device 120 may receive an input to ignore transactions that are necessary for the user (e.g., a recurring daycare payment for a user's child). In these embodiments, the provider computing system 102 may be configured to not extract the defined transactions and not provide the transactions as an input to the AI engine 108. This allows the provider computing system 102 to operate in a non-conventional manner by allowing a user to selectively determine what transaction history is analyzed for determining an impact for a common goal. This provides a practical application, allowing a user to ignore transactions that are related to sensitive information and/or necessary transactions.

The AI engine 108 may be configured to train the individual models (and group models) using transaction or financial history data, to determine behaviors (e.g., transactions) which have a positive (or negative) impact on a particular goal or objective for the individual and group, respectively. In some embodiments, the AI engine 108 may be configured to simulate various performance scenarios (e.g., predicted/likely/routine transactions) to generate, determine, or otherwise identify various predicted (synthetic) output performances relative to a group goal (e.g., hypothetical scenarios). For example, the AI engine 108 may be configured to train the individual models to analyze individual behavior of each user of the group account (e.g., individual transactions with the group account and/or their respective individual transaction history) to determine an impact of an individual's interactions with the group account relative to an individual's goal and train the group models to analyze each individual behavior together to determine a positive or negative impact on each of the individual's interactions with the group account relative to a group goal. In some implementations, the AI engine 108 may be configured to use one or more outputs of the individual models as an input to the group models to forecast goal achievement likelihood.

The AI engine 108 may be configured to analyze, parse, inspect, or otherwise ingest transaction history of respective individual members (e.g., spending, savings, transaction history with the member's personal account(s) relative to their respective individual goals), to determine/predict/evaluate how the individual transaction history impacts the individual/group goals. For example, the AI engine 108 may be configured to execute one or more generative adversarial imitation (GAI) simulations on the individual transaction history to predict future transactions for the corresponding individual (e.g., relative to the shared account and/or the individual's personal account(s)). The AI engine 108 may be configured to evaluate the predicted future transactions against the individual/group goals, to identify a likelihood of satisfying the individual/group goals. In some embodiments, the AI engine 108 may be configured to identify, determine, select, or otherwise generate behavioral changes in response to determining that the likelihood of satisfying the individual/group goals satisfies a threshold (e.g., is less than a predetermined threshold of likelihood). The AI engine 108 may be configured to generate the behavioral changes by eliminating/removing one or more of the predicted transactions from a plurality of predicted transactions (e.g., removing, for example, high value predicted transactions which are not contributions to the shared account, removing one or more instances of repeat transactions which are not contributions to the shared account, etc.). In some embodiments, the AI engine 108 may be configured to generate the behavioral changes by suggesting/providing one or more additional predicted transactions to the plurality of predicted transactions (e.g., by increasing an amount of a regularly-scheduled contribution to the shared account, increasing a periodicity of scheduled contributions, adding a lump-sum contribution to the shared account, etc.). The AI engine 108 may be configured to re-execute the GAI simulation(s) according to the behavioral changes, to re-determine the likelihood of satisfying the individual/group goals. The AI engine 108 may be configured to iteratively repeat the processes until identifying behavioral changes which are likely to result in achieving the individual/group goals.

In some embodiments, the provider computer system 102 may perform steps 402 and 404 for each shared member of the shared account. For example, the provider computer system 102 may perform step 402 at enrollment of each member to the shared account. The provider computer system 102 may perform step 404 at enrollment and at various intervals (e.g., daily, weekly, monthly, etc.) for each member. The provider computer system 102 may perform step 404, to identify opportunities for additional savings to the shared account (e.g., individual opportunities, group opportunities, etc.), as described in greater detail below.

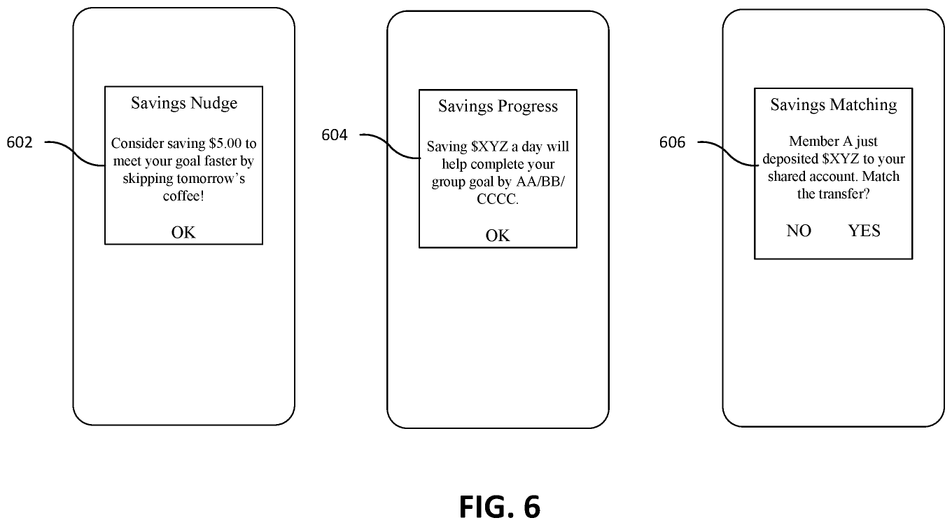

At step 406, the provider computer system 102 may communicate, transmit, provide, or otherwise send one or more first notification(s) regarding a first set of opportunities (e.g., individual opportunities) for savings to the shared account. In some embodiments, the provider computer system 102 may generate the one or more first notification(s) based on or according to the analysis at step 404. For example, the provider computer system 102 may generate the one or more first notifications for individual members, based on or according to analysis of the transaction history for their respective individual accounts. The provider computer system 102 may generate the one or more first notifications based on trends or savings opportunities identified by the AI engine 108 based on analysis of the transaction history. The AI engine 108 may identify the trends or savings opportunities based on or according to various simulated outputs or synthetic output performances. The notifications sent at step 406 may be similar to the notification 602 shown in FIG. 6. For example, and as shown in FIG. 6, the AI engine 108 may identify a trend of a daily purchase at a coffee shop. The provider computer system 102 may generate a notification 602 regarding the identified trend (e.g., “Consider saving $5.00 to meet your goal faster by skipping tomorrow's coffee!”).

At step 408, the provider computer system 102 may maintain, identify, or otherwise store data indicative of a deposit history. The deposit history may be a record of deposits from respective individual accounts to the shared account. The provider computer system 102 may update the record based on new deposits (e.g., inbound transfers from an individual account to the shared account). In some instances, new deposits may occur responsive to individual notification(s), such as those sent at step 406. As such, the provider computer system 102 may maintain data indicative of a progress towards the goal(s) 302 of the shared account.

Similar to step 406, at step 410, the provider computer system 102 may transmit, communicate, send, or otherwise provide one or more second notification(s) regarding a second set of opportunities (e.g., group savings opportunities). The provider computer system 102 (e.g., the AI engine 108) may determine the second set of opportunities based on the data indicative of the progress towards the goal(s) 302 of the shared account. For example, the provider computer system 102 may analyze the data indicative of the deposit history, to identify group savings opportunities. The notifications sent at step 410 may be similar to the notification 604 shown in FIG. 6. For example, and as shown in FIG. 6, the AI engine 108 may identify group savings opportunities based on a current date (e.g., a date of the notification), a target date (e.g., the target date of the goal 302), a current amount or value of the shared account (e.g., from the deposit history), a target amount of the goal 302, and a number of shared members. The provider computer system 102 may generate a notification 604 regarding the identified opportunity (e.g., “Saving $XYZ a day will help complete your group goal by AA/BB/CCCC.”), where $XYZ is computed based on a difference between the current date and target date (e.g., AA/BB/CCCC), a difference between the current value and target amount or value, and the number of shared members.

In some embodiments, the provider computer system 102 may transmit the notification(s) at step 410 to each of the shared members. The provider computer system 102 may transmit the notification(s) according to the notification policy 304 for the shared account. In other words, the provider computer system 102 may transmit various notifications, e.g., including those sent at step 406 and step 410, according to the notification policy 304.

In some embodiments, the provider computer system 102 may transmit notifications identifying when a goal was not reached. For example, the provider computer system 102 may generate and transmit notifications in response to determining that the goal was not met by the target date. The notification(s) may be sent on an individual and/or group basis. The notification(s) may include recommendations for achieving various future goals (e.g., identifying transactions that may have led to missing the goal on an individual basis, which can also be fed as an input by the AI engine 108 for revising the individual model for the user).

In some embodiments, the notification(s) may include various fields for initiating a transfer of funds (e.g., an inbound transfer from an individual account to the shared account). For example, the notification(s) may include a field for selecting whether (or not) to initiate a transfer, an amount to transfer, a frequency/periodicity/cadence for the transfer (e.g., a one time or recurring transfer), etc. A user of the customer device 120, upon receiving the notification, may generate various responses to the notification (e.g., declining a transfer, initiating a one-time transfer, initiating or establishing a recurring transfer, etc.).

At step 412, the provider computer system 102 may record, maintain, or otherwise store data indicative of notification responses. In some embodiments, the provider computing system 102 may store data indicative of notification responses in association with the shared member. For example, where a user or member declines or initiates an inbound transfer in response to a notification, the provider computer system 102 may store data corresponding to the response in association with the account of the user or member. The provider computer system 102 may use the data indicative of the response for providing additional or alternative notifications. For example, where a user is more prone to positively respond to individual opportunities rather than group opportunities, the provider computer system 102 may use the data indicative of the responses as feedback for modifying or tuning notifications sent to the user (e.g., send more individual opportunities and less group opportunities, identify additional individual savings opportunities, etc.).

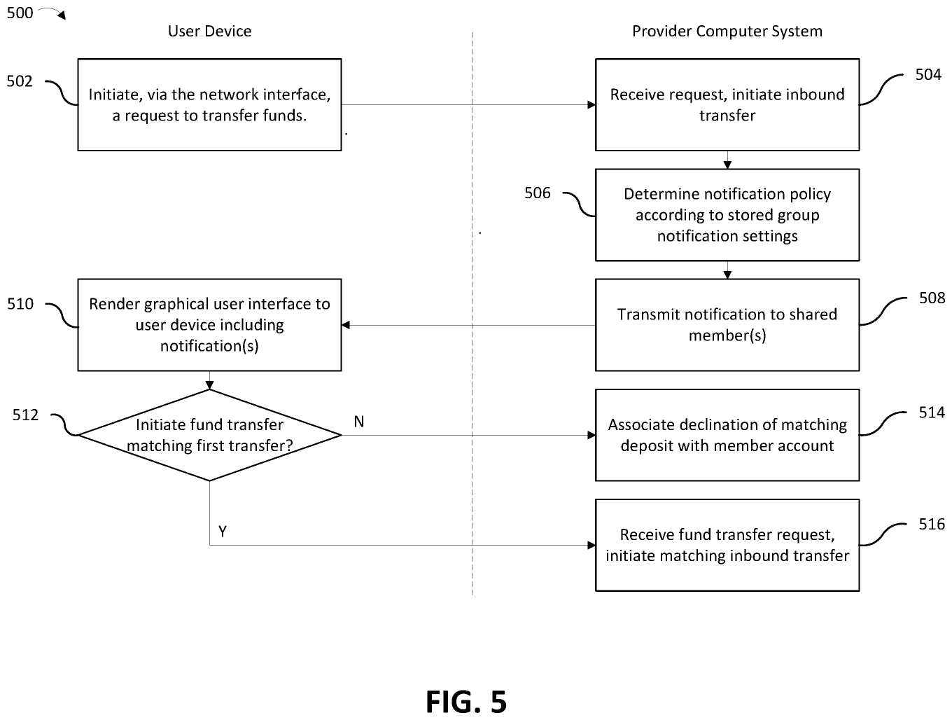

Referring now to FIG. 5, depicted is a flowchart showing an example method 500 of providing notifications regarding matching inbound transfers, according to an example implementation of the present disclosure. As shown in FIG. 5, the method 500 may be performed in part by a customer or user device (such as the customer device 120 described above) and the provider computer system 102.

At step 502, a user device may generate or otherwise initiate a request to transfer funds. In some embodiments, the user device may initiate, via a network interface 122, a request to transfer funds from a first account (e.g., an individual account) to a shared account. The user device may initiate the request to transfer funds responsive to or according to various user inputs to the user device (e.g., to the client application 126). The request may include an amount and identify an account from which to initiate the transfer (e.g., the individual account, particularly if more than one individual account of the user is linked to the shared account).

At step 504, the provider computer system 102 may receive, via the network interface, the request generated or initiated at step 502. In some embodiments, the provider computer system 102 may receive a first input (e.g., the request) via the first user device indicating a selection to initiate an inbound transfer from the first account to the shared account, to increase a value associated with the shared account by an amount. The provider computer system 102 may receive the input responsive to the user device transmitting the request via the network 150 to the provider computer system 102. The provider computer system 102 may determine the amount (and account) specified in the request. The provider computer system 102 may initiate the transfer of funds according to the request received at step 504. For example, the provider computer system 102 may initiate the transfer of funds by generating various messages to cause the amount of funds to be transferred from the account of the request to the shared account.

At step 506, the provider computer system 102 may identify or determine a notification policy associated with the shared account. As described above with reference to FIG. 3, the provider computer system 102 may receive various notification settings 304 for establishing the notification policy for the shared account. The provider computer system 102 may determine the notification policy according to the notification settings 304 for the shared account. The provider computer system 102 may determine the notification policy, for identifying whether or not to generate one or more notifications relating to the request received at step 504.

At step 508, the provider computer system 102 may generate and communicate, transmit, send, or otherwise provide one or more notification(s) to shared members. In some embodiments, the provider computer system 102 may transmit one or more notifications to one or more second user devices (e.g., of shared members other than the shared member which initiated the transfer at step 502). The provider computer system 102 may transmit the notification(s) according to the notification policy determined at step 506. The provider computer system 102 may transmit the notification(s) via the network 150 to the second user device(s).

At step 510, the second user device(s) may display, establish, or otherwise render a graphical user interface (GUI) including the notification(s) sent at step 508. The second user device(s) may render the GUI responsive to receiving the notification via a network interface from the provider computer system 102. In some embodiments, the notification sent at step 508 and rendered at step 510 may be similar to the notification 606 of FIG. 6. For example, as shown in FIG. 6, the notification 606 may indicate the transfer of funds initiated at step 502 and request the user to match the transfer (e.g., “Member A just deposited $XYZ to your shared account. Match the transfer?”). The notification 606 may include fields or user interface elements for selecting whether or not to initiate a matching transfer of funds.

At step 512, the user of the second device may select whether or not to initiate a fund transfer matching the first transfer (e.g., of step 502) or in another amount (e.g., an increased amount such that it encourages members to increase their contributions in a subsequent fashion). The provider computer system 102 may determine a response to the notification based on selection of the corresponding user interface element of the corresponding notification. The provider computer system 102 may receive a response to the notification via the network 150 from the second device. The response may include an acceptance or declination of the matching inbound transfer.

At step 514, where the response is a declination of the matching inbound transfer, the provider computer system 102 store an association of the response with the account of the user of the second device. The provider computer system 102 may use the stored association of the response as feedback for subsequent notifications to the user of the second device. For example, the provider computer system 102 may provide more individual opportunities (such as those sent at step 406 of FIG. 4) or group opportunities (such as those sent at step 410), rather than opportunities to match inbound transfers. As such, by storing data indicative of responses (e.g., to the various notifications described herein), the systems and methods described herein can adaptively send notifications on an individual basis which are more likely to result in inbound transfers.

At step 516, where a response is an acceptance of the matching inbound transfer, the provider computer system 102 may thus receive a second input via the second user device indicating a selection to initiate a matching inbound transfer to the shared account, to increase the value associated with the shared account by the amount. Step 516 may be similar to step 504 described above. The provider computer system 102 may initiate the matching inbound transfer according to the response to the notification. In some embodiments, and similar to step 514, the provider computer system 102 may store an association of the acceptance with the account of the second user. The provider computer system 102 may use the acceptance to fine tune notifications sent to the second user (e.g., similar to the declination) to provide targeted notifications to the second user more likely to result in inbound transfers (e.g., more notifications for matching inbound transfers and less individual or group opportunities, etc.). In this regard, the provider computer system 102 (e.g., the AI engine 108) may adaptively learn individual responsiveness to notifications, and send targeted notifications to users that are most likely to result in a positive response.

According to the systems and methods described herein, the AI engine 108 together with the provider computer system 102 may provide notifications to facilitate end users to achieve their group goal. By providing notifications as described herein (e.g., on an individual or group basis), particularly those which attempt to modify behavior, the systems and methods described herein may provide timely notifications which facilitate achieving the group goal. The systems and methods described herein can retrain individual or group models based on respective behavior (as indicated by responses to notifications, individual transaction history, etc.), to provide more targeted notifications most likely to encourage achieving the group goals (and discourage mal-intent from individuals).

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112 (f), unless the element is expressly recited using the phrase “means for.”

As used herein, the term “circuit” may include hardware structured to execute the functions described herein. In some embodiments, each respective “circuit” may include software for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

Accordingly, the “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A computing system, comprising:
a network interface;
a database structured to store a plurality of shared accounts containing group member information; and
a processing circuit comprising one or more processors and a memory, the processing circuit configured to:
receive, via the network interface, a request from a first user device associated with a first member to form a shared account with one or more second members, the request including information for identifying a first account of the first member;
generate, in the database, the shared account and a first model for the shared account, the shared account including a first link between the shared account and the first account, and the first model generated according to the shared account;
transmit, via the network interface, one or more messages to one or more second user devices associated with the one or more second members;
generate, in the database, one or more second links between one or more second accounts of the one or more second members and the shared account, the one or more second links generated according to a response to the one or more messages received from the one or more second user devices;
generate one or more second models for the first member and the one or more second members, the one or more second models generated according to information relating to respective members of the first member and the one or more second members;
receive, via the network interface, a first input via the first user device initiating an inbound transfer from the first account to the shared account to increase a value associated with the shared account by an amount; and
transmit, via the network interface, according to the first model and at least one second model of the one or more second models, a notification to the one or more second user devices; and
receive, via the network interface, a second input via at least one second user device indicating a selection to initiate a matching inbound transfer to the shared account, to increase the value associated with the shared account by the amount.

2. The computing system of claim 1, wherein the processing circuit is further configured to receive, via the network interface from at least one of the first user device or the one or more second user devices, data indicative of a notification policy for the shared account.

3. The computing system of claim 2, wherein the data indicative of the notification policy for the shared account is received from the first user device with the request to form the shared account.

4. The computing system of claim 1, wherein transmitting the notification to the at least one second user device comprises:
transmitting, via the network interface according to the first model and the at least one second model, a first notification to the at least one second user device; and
transmitting, via the network interface according to the first model and at least one other second model, a second notification to at least one other second user device.

5. The computing system of claim 4, wherein the processing circuit is further configured to:
receive, via the network interface, from the at least one other second user device, a declination of the matching inbound transfer; and
update the at least one other second model according to the declination.

6. The computing system of claim 1, wherein the processing circuit is further configured to:
determine, for a second user of the one or more second members, a transaction history associated with a second account of the second user;
determine, according to the transaction history, a recommendation for a second inbound transfer; and
transmit, via the network interface, according to a second model of the one or more second models corresponding to the second member, data corresponding to the recommendation to a device of the second user.

7. The computing system of claim 1, wherein the processing circuit is further configured to:
receive, via the network interface, data indicative of one or more target values of the shared account and a corresponding target date; and
store an association of the one or more target values and the corresponding target date with data corresponding to the shared account.

8. The computing system of claim 7, wherein the processing circuit is further configured to transmit, via the network interface according to the first model, one or more notifications based on a difference between a current value associated with the shared account and the one or more target values and a difference between a current date and the corresponding date.

9. The computing system of claim 7, wherein the data indicative of the one or more target values and the corresponding date is received with the request to form the shared account.

10. A method, comprising:
receiving, by a computing system, a request from a first user device associated with a first member, the request to form a shared account with one or more second members, the request including information identifying a first account of the first member;
generating, by the computing system, the shared account and a first model for the shared account, the shared account including a first link between the shared account and the first account, and the first model generated according the shared account;
transmitting, by the computing system, one or more messages to one or more second user devices associated with the one or more second members;
generating, by the computing system, one or more second links between one or more second accounts of the one or more second members and the shared account, the one or more second links generated according to a response to the one or more messages received from the one or more second user devices;
generating, by the computing system, one or more second models for the first member and the one or more second members, the one or more second models generated according information relating to respective members of the first member and the one or more second members;
receiving, by the computing system, a first input via the first user device initiating an inbound transfer from the first account to the shared account that increases a value associated with the shared account by an amount;
transmitting, by the computing system, according to the first model and at least one second model of the one or more second models, a notification to at least one second user device corresponding to the at least one second model; and
receiving, by the computing system, a second input via a second user device indicating a selection to initiate a matching inbound transfer to the shared account, to increase the value associated with the shared account by the amount.

11. The method of claim 10, further comprising receiving, by the computing system from at least one of the first user device or the one or more second user devices, data indicative of a notification policy for the shared account.

12. The method of claim 11, wherein the data indicative of the notification policy for the shared account is received from the first user device with the request to form the shared account.

13. The method of claim 10, wherein transmitting the notification to the at least one second user devices comprises:
transmitting, by the computing system according to the first model and the at least one second model, a first notification to the at least one second user device; and
transmitting, by the computing system according to the first model and at least one other second model, a second notification to at least one other second user device.

14. The method of claim 13, further comprising:
receiving, by the computing system from the at least one other second user device, a declination of the matching inbound transfer; and
updating, by the computing system, the at least one other second model according to the declination.

15. The method of claim 10, further comprising:
determining, by the computing system and for a second user of the one or more second members, a transaction history associated with a second account of the second user;
determining, by the computing system and according to the transaction history, a recommendation for a second inbound transfer; and
transmitting, by the computing system according to a second model of the one or more second models corresponding to the second member, data corresponding to the recommendation to a device of the second user.

16. The method of claim 10, further comprising:
receiving, by the computing system, data indicative of one or more target values of the shared account and a corresponding target date; and
storing, by the computing system, an association of the one or more target values and the corresponding target date with data corresponding to the shared account.

17. The method of claim 16, further comprising transmitting, by the computing system according to the first model, one or more notifications based on a difference between a current value associated with the shared account and the one or more target values and a difference between a current date and the corresponding date.

18. The method of claim 16, wherein the data indicative of the one or more target values and the corresponding date is received with the request to form the shared account.

19. The method of claim 1, further comprising initiating, by the computing system, the inbound transfer and the matching inbound transfer according to the first input and the second input.

20. A non-transitory computer readable medium storing instructions that, when executed by one or more processors of a processing system, cause the processing system to:
receive, via a network interface, a request from a first user device associated with a first member to form a shared account with one or more second members, the request including information for identifying a first account of the first member;
generate, in a database, the shared account and a first model for the shared account, the shared account including a first link between the shared account and the first account, and the first model generated according to the shared account;
transmit, via the network interface, one or more messages to one or more second user devices associated with the one or more second members;
generate, in the database, one or more second links between one or more second accounts of the one or more second members and the shared account, the one or more second links generated according to a response to the one or more messages received from the one or more second user devices;
generate one or more second models for the first member and the one or more second members, the one or more second models generated according to information relating to respective members of the first member and the one or more second members;
receive, via the network interface, a first input via the first user device initiating an inbound transfer from the first account to the shared account that increases a value associated with the shared account by an amount;
transmit, via the network interface, according to the first model and at least one second model of the one or more second models, a notification to the one or more second user devices; and
receive, via the network interface, a second input via at least one second user device initiating a matching inbound transfer to the shared account that increases the value associated with the shared account by the amount.
